(19) United States
(12) Patent Application Publication
(10) Pub. No.: US 2007/0077808 A1
(43) Pub. Date: Apr. 5, 2007

(54) Feeder for tumblers

(75) Inventors: Wallace Grubb, Longueuil (CA); Benoit Slavinski, St-Hubert (CA); Vincent McCutcheon, St-Jean-sur-Richelieu (CA)

Correspondence Address: VENABLE LLP, P.O. BOX 34385, WASHINGTON, DC, 20043-9998, US

(73) Assignee: Grubb-AMC Inc., Quebec (CA)

(21) Appl. No.: 11/529,584

(22) Filed: Sep. 29, 2006

Related U.S. Application Data
(60) Provisional application No. 60/721,529, filed on Sep. 29, 2005.

(51) Int. Cl. H01R 3/00

(52) U.S. Cl. 439/491

(57) ABSTRACT

A feeder to supply blocks to a tumbler having a block inlet from a generally horizontal platform, the feeder comprising a frame and a shelf assembly so mounted to the frame as to reciprocate between a block receiving position and a block dumping position; the shelf assembly generally aligned with the platform when the shelf assembly is in the block receiving position to receive at least one block thereupon from the platform; the shelf assembly being so movable as to be angled into a block dumping position to cause the blocks to slide from the shelf assembly to the inlet of the tumbler.

### CROSS-REFERENCE TO RELATED APPLICATION

This application claims the priority of U.S. Provisional Application No. 60/721,529 filed Sep. 29, 2005, the subject matter of which is incorporated herein by reference.

### FIELD OF THE INVENTION

The present apparatus concerns apparatuses for concrete pavers surfacing and more specifically tumblers. More specifically, the present invention concerns a feeder for such apparatuses.

### BACKGROUND OF THE INVENTION

Tumblers are well-known in the art of concrete block aging, which aims at creating paving stone having a realistic aged looked.

According to a first method from the prior art, the concrete blocks are directly dumped in the tumbler from a belt conveyor ending its course in the tumbler's inlet. A first drawback of such method is that conveyor belts take precious working space in a pavers aging processing plant, especially when they are more than one tumbler to feed. Another major drawback of such system is that the concrete blocks have to be first discharged from a cubical stack of blocks (hereinafter referred to as a “cube”) to the conveyor, which often results in damages to the blocks.

United States Patent Application No. 2001/0012482 A1 filed by Vezina in 2000 and entitled “Dumping Device for Concrete Blocks, Bricks, Paving Stones or the Like” describes a dumping device which solves the problem of space raised by the use of conveyor belts since a cube is directly charged onto Vezina's device. However, a drawback of Vezina's device is that the blocks are pushed from 1) a nearly vertical position and 2) too high relative to their final destination, yielding a sufficiently violent fall of the blocks to cause undesired damages thereto.

### SUMMARY OF THE INVENTION

In accordance with an aspect of the present invention, there is provided a feeder to supply blocks from a platform to a tumbler having a block inlet, the feeder comprising a frame to be positioned adjacent the platform and the tumbler; and a shelf assembly including a back plate, two side walls mounted to the back plate on opposite sides thereof and a shelf mounted to the back plate between the two side plates; the shelf assembly being so mounted to the frame for reciprocal movement between a block receiving position wherein the shelf is generally aligned with the platform to receive at least one block thereupon from the platform and a block dumping position wherein the back plate is generally angled with respect to the block inlet of the tumbler to cause the at least one block to slide from the shelf assembly to the inlet of the tumbler.

According to another aspect of the present invention, there is provided a method to transfer blocks from a platform to a tumbler provided with a block inlet; the method comprising providing a shelf assembly including a shelf mounted to a back plate; positioning the shelf assembly in a block receiving position where the shelf is generally aligned with the platform to receive blocks thereupon from the platform; transferring blocks from the platform to the shelf of the shelf assembly; and moving the shelf assembly in a block dumping position where the back plate is generally angled with respect to the block inlet of the tumbler to cause the blocks to slide from the shelf assembly to the block inlet of the tumbler.

According to further aspect of the present invention, there is provided a concrete pavers aging processing chain comprising at least two generally longitudinal tumblers provided with respective inlets; the tumblers being positioned generally parallel; a cube-receiving platform provided with a push-arm; tracks running laterally between the at least two tumblers and the cube receiving platform; a block feeder to supply blocks to the at least two tumbler from the platform, the block feeder including a frame so configured as to be movable along the tracks for moving the block feeder from the platform to a selected one of the at least two tumblers; the block feeder also including a shelf assembly including a back plate, two side walls mounted to the back plate on opposite sides thereof and a shelf mounted to the back plate between the two side plates; the shelf assembly being so mounted to the frame for reciprocal movement between a block receiving position wherein the shelf is generally aligned with the cube-receiving platform to receive at least one block thereupon from the platform and a block dumping position wherein the back plate is generally angled with respect to the block inlet of the selected one of the at least two tumblers to cause the at least one block to slide from the shelf assembly to the inlet of the selected one of the at least two tumblers.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a front perspective view of a feeder for tumblers according to a first illustrative embodiment of the present invention, the feeder being illustrated positioned adjacent a tumbler's inlet;

FIG. 2 is a back perspective of the feeder from FIG. 1;

FIG. 3 is a cross-section of the feeder from FIG. 1, illustrated in an initial non-operating position between the tumbler and concrete blocks on a cube-receiving platform;

FIG. 4 is a cross-section similar to FIG. 3, illustrating the feeder in a section-receiving position;

FIG. 5 is a cross-section similar to FIG. 3, illustrating the charging of a section of blocks in the feeder from the cube;

FIGS. 6 and 7 are cross-sections similar to FIG. 3, illustrating the feeder in transitional states between the charging of a section of concrete blocks and dumping of the blocks in the tumbler;

FIG. 8 is a cross-section similar to FIG. 3, illustrating the feeder of FIG. 1 in a block dumping position allowing gentle dumping of the concrete blocks in the tumbler;

FIG. 9 is a cross-section similar to FIG. 3, illustrating the feeder returning to the initial position of FIG. 3;

FIG. 10 is a cross-section similar to FIG. 4 and illustrating a second illustrative embodiment of the feeder in a section-receiving position;

FIG. 11 is a top plan view of a feeder for tumblers according to a third illustrative embodiment of the present invention, the feeder being illustrated part of a concrete pavers aging processing chain further including three tumblers and a cube-receiving and pushing platform;

FIG. 12 is a back perspective view of the feeder for tumblers from FIG. 11, the feeder being illustrated positioned adjacent one of the tumblers' inlets and in a block dumping position similar to FIG. 8;

FIG. 13 is an isolate perspective view of the feeder of FIG. 12; and

FIG. 14 is a cross-section of the feeder from FIG. 12, illustrating the feeder adjacent one of the tumblers from FIG. 11 in a dumping position.

### DETAILED DESCRIPTION

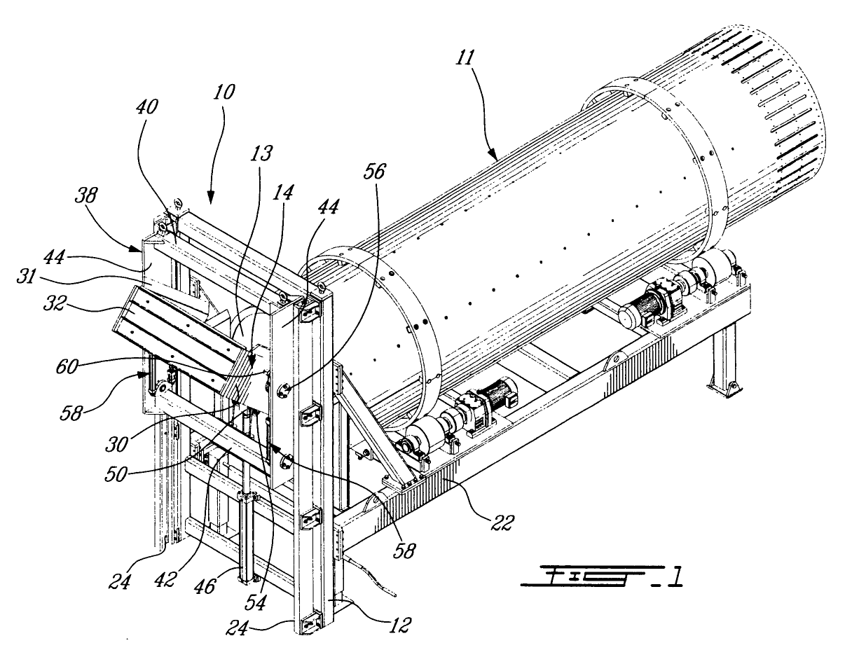

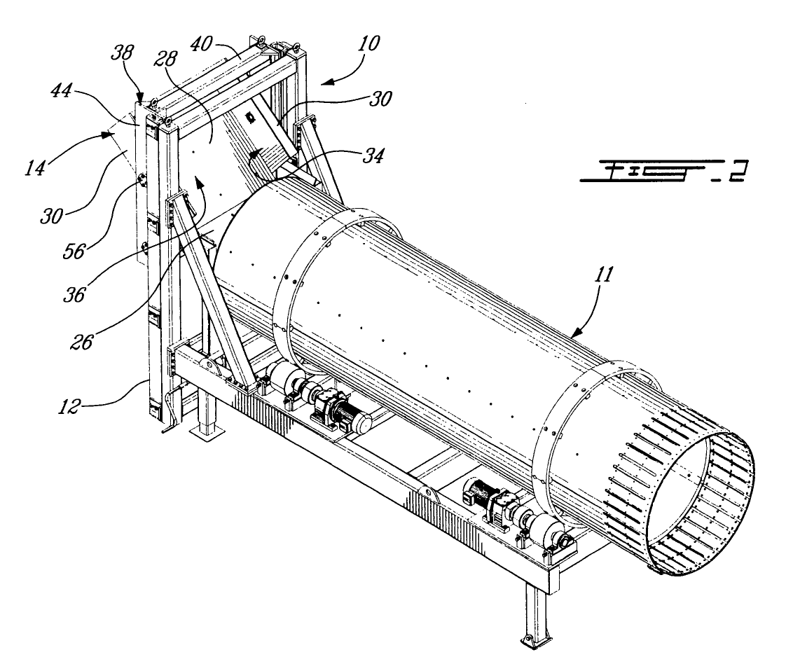

A feeder 10 designed to supply concrete blocks to a tumbler 11 according to a first illustrative embodiment of the present invention will now be described with reference to FIGS. 1-2.

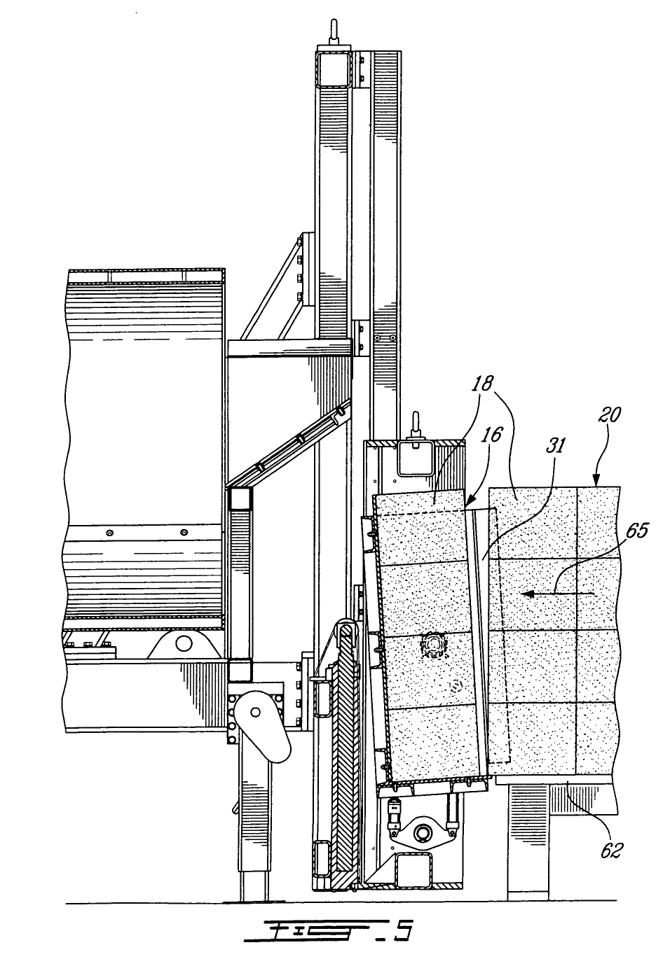

The feeder 10, which is shown in a block dumping position in FIGS. 1 and 2, includes a fixed upright generally rectangular frame 12 to be mounted adjacent the block inlet 13 of the tumbler 11, and a shelf assembly 14 both pivotally and slidably mounted to the frame 12. The shelf assembly 14 is so designed as to receive a section 16 of concrete blocks 18 from a cube 20 (see FIG. 5) and to gently guide the blocks 18 of the section 16 in the tumbler 11 as will be explained hereinbelow in more detail.

Since tumblers and autotumblers are believed to be well-known in the art, and for concision purposes, they will not be described herein in more detail.

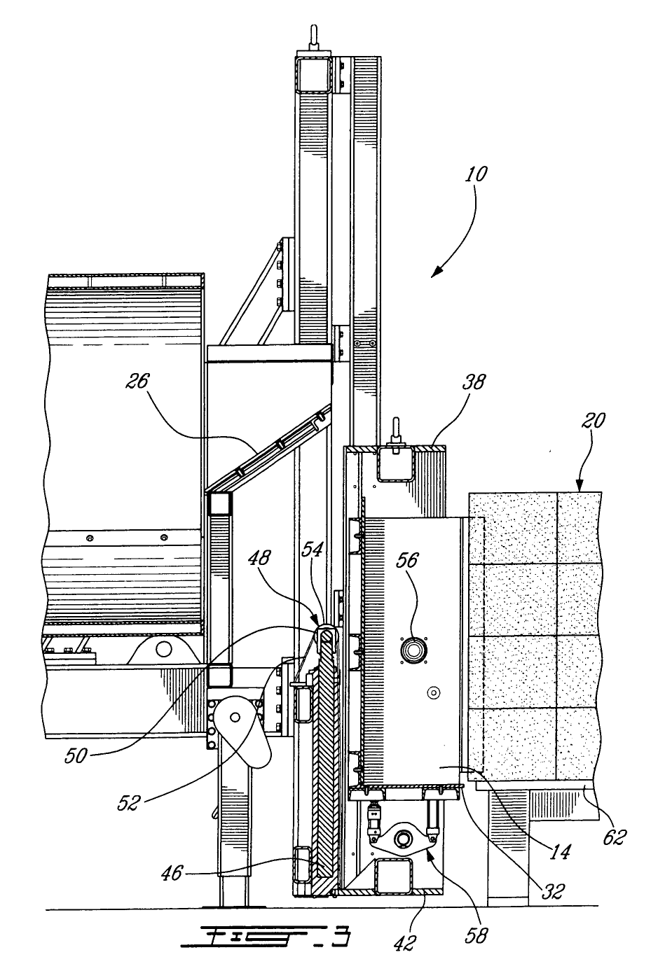

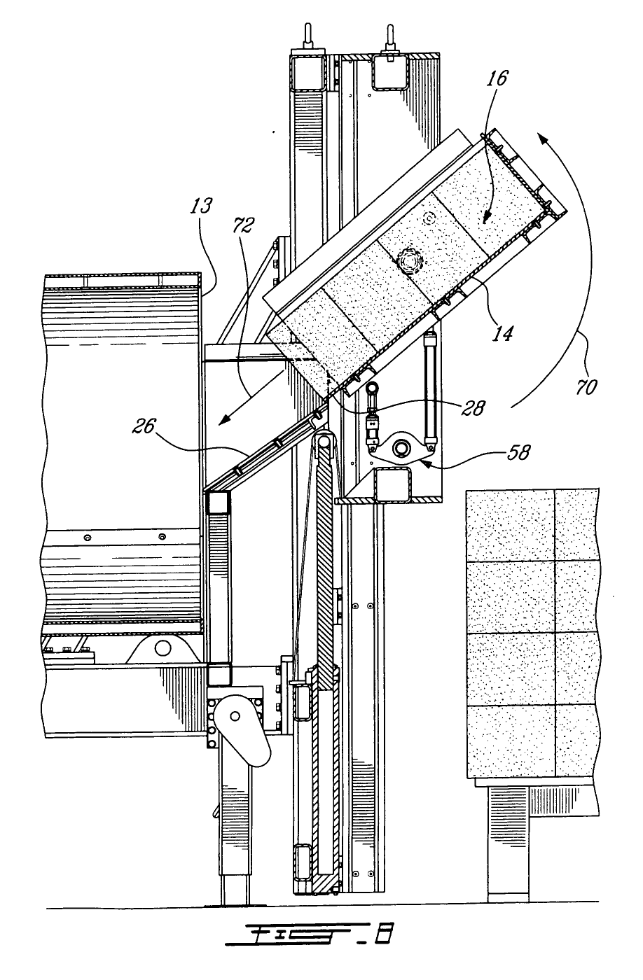

The fixed upright frame 12 is either secured to the ground next to the tumbler's inlet 13 or secured directly to the tumbler 11 via its frame 22. The frame 12 includes two opposite side rails 24 for receiving the shelf assembly 14 and for allowing reciprocal upward and downward movements of the shelf assembly 14 along the frame 12. The frame 12 further includes a chute 26, which is better seen on FIG. 3, for completing the back plate 28 of the shelf assembly 14 when the shelf assembly 14 is in a dumping position (see FIG. 8) as will be explained hereinbelow. The chute 26 can be secured either to the frame 12 of the feeder 10 or directly to the tumbler 11.

The shelf assembly 14 is generally rectangular in shape and includes a back plate 28, two side walls 30 and a shelf 32. The shelf assembly 14 has a first open feeding side 34 opposite the back plate 28 and a second open dumping side 36 opposite the shelf 32.

The shelf assembly 14 is slidably mounted to the upright frame 12 via a shelf mounting frame 38. The mounting frame 38 is in the form of a rectangular frame having top 40, bottom 42 and two side frame members 44. The two side frame members 44 are provided with rollers (not shown) for respective operative cooperation in the side rails 24, thereby allowing the shelf assembly 14 to be slidably mounted to the upright frame 12. The rollers can be replaced by other side-rail cooperating elements. Of course, alternatively, the upright frame 12 can be provided with rollers and the mounting frame with side rails.

Reciprocal movements of the mounting frame 38 along the upright frame 12 are provided by an actuator, in the form of a piston 46, acting on the mounting frame 38 via a pulley assembly 48 including a double pulley 50 and two leaf chains 52 (only one shown), which can be better seen from FIGS. 3 to 9. Cables or the likes can be used in place of the leaf chains.

The piston 46, which is either pneumatic or hydraulic, is located below the mounting frame 38 and is provided with the double pulley 50 at the distal end of its piston. Each of the two cables 52 is secured at one end to the fixed upright frame 12, runs over a respective wheel 54 of the double pulley 50 and is secured at the other end to the bottom frame member 42 of the mounting frame 38.

The shelf assembly 14 is further pivotally mounted to the mounting frame 38 via two pivot pin assemblies 56. Since such pivot pin assemblies 56 are believed to be well-known in the art, and for concision purposes, they will not be described herein in more detail.

Two telescoping pivot arm assemblies 58 are provided on each side of the shelf assembly 14 to control the pivotal movement of the shelf assembly 14 with respect to the mounting frame 38. Each pivot arm assembly 58 has a proximate end secured to a respective side frame member 44 of the mounting frame 38 and a distal end 60 secured to a respective side wall 30 of the shelf assembly 14. The required tilting effect and force are achieved both by the configuration and size of the telescoping pivot arm assemblies 58 or by adjusting the distance between the distal end 60 and pivot point 56. Other pivoting assemblies, such as motors directly mounted on the pivot pin assemblies 56, can be used in place of the telescoping pivot arm assemblies 58.

Both the piston 46 and the pivot arm assemblies 58 are triggered and controlled by conventional controllers (not shown).

The operation of the feeder 10 will now be described with reference to FIGS. 3 to 9.

In FIG. 3, the feeder 10 is illustrated in an initial non-operating position. In this position, the shelf assembly 14 is generally aligned with the mounting frame 38.

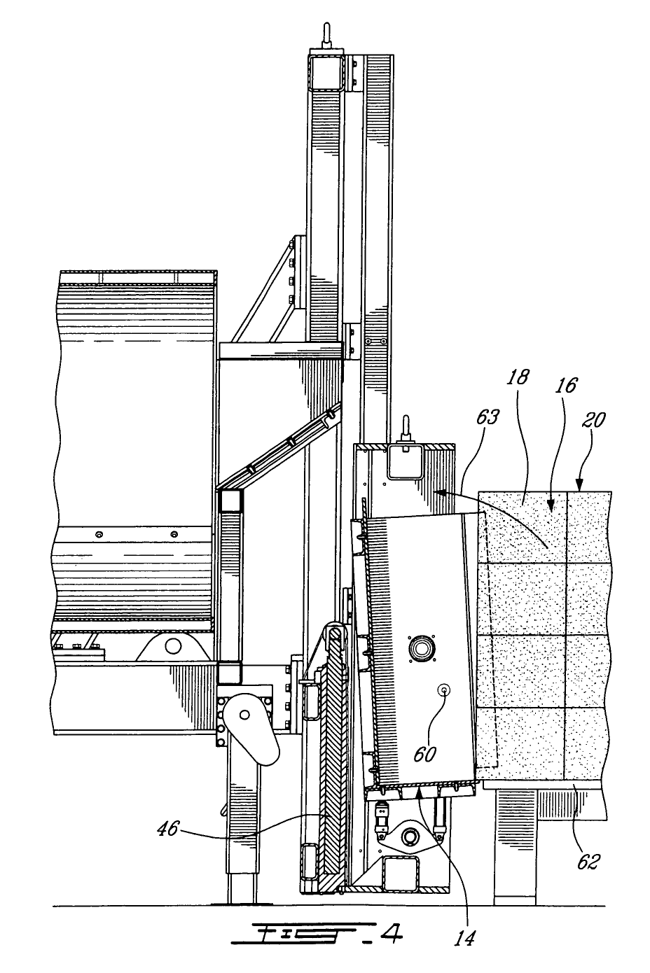

As illustrated in FIG. 4, the shelf assembly 14 is then tilted away from the platform 62 by a few degrees (see arrow 63) relative to the mounting frame 38 so as to position the feeder in a block section-receiving position where a section 16 of blocks 18 may be transferred from the cube receiving platform 62 to the shelf assembly 14. As can be seen from this figure, the shelf assembly is generally aligned with the cube receiving platform.

In the next step, illustrated in FIG. 5, a push-arm (not shown) of the cube-receiving platform 62 is actuated so as to push one vertical section 16 of concrete pavers blocks 18 onto the shelf assembly 14 (see arrow 65). The feeder 10, and more specifically the shelf assembly 14, may be configured and sized so as to simultaneously receive more than one section of blocks 18. Of course, in that case, the movement of the pusher arm is configured to push the appropriate number of sections in the shelf assembly 14.

The shelf assembly 14 is leveled with the platform 62 so as to facilitate the feeding of the section of blocks 18 in the shelf assembly 14. A person skilled in the art would appreciate that a position of the shelf assembly 14 slightly below the platform would also allow charging the section 64 in the box without damaging the blocks 18.

It has been found that the tilt given to the shelf assembly 14 provides increased stability to the section while it is charged in the shelf assembly 14.

It is to be noted that the side walls 30 of the shelf assembly 14 are provided with flaring extensions 31 (see FIGS. 1 and 5) that guide the section of blocks 16 onto the shelf 32 should there be misalignment between the frame 12 and the platform 62.

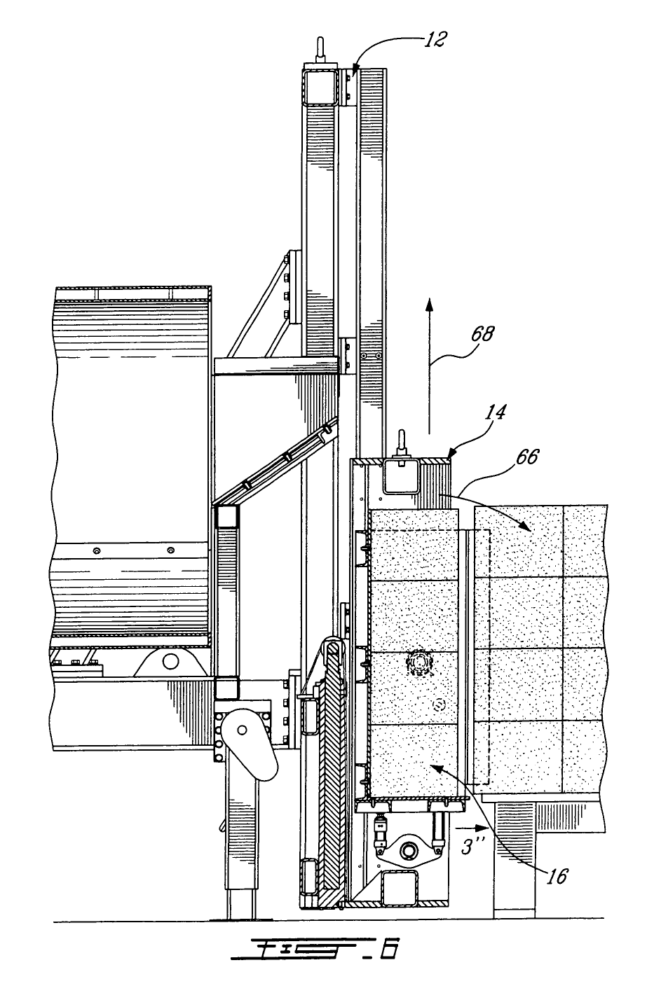

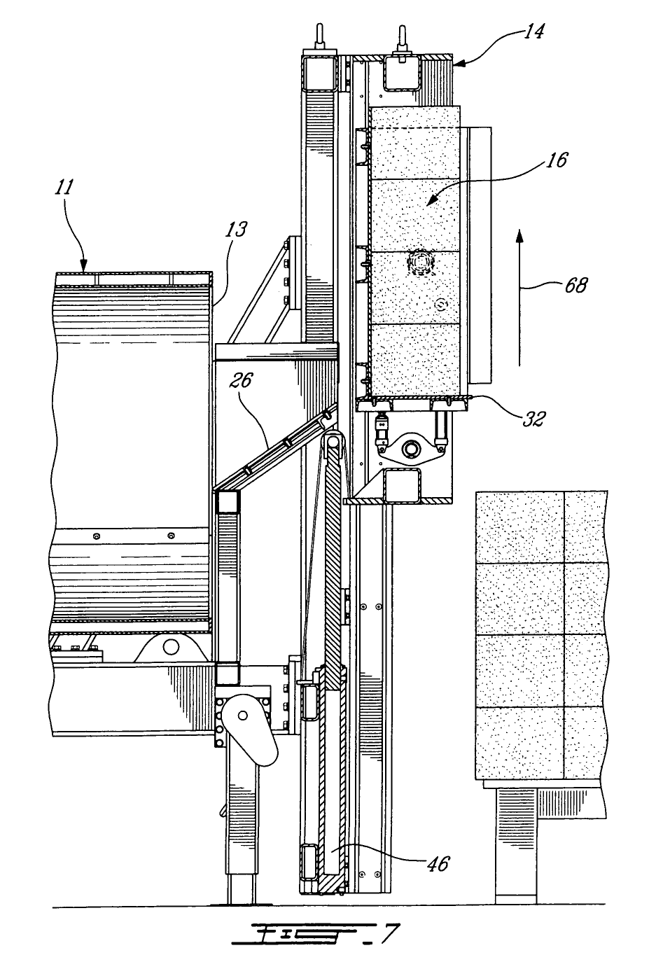

As illustrated in FIGS. 6 and 7, the shelf assembly 14 is then tilted back (see arrow 66 in FIG. 6) to a position parallel to the upright frame 12 and it is raised along the upright frame 12 (see arrow 68) by the piston 46 until the shelf 32 is near the top of the chute 26 (see FIG. 7).

Via the telescoping pivot arm assemblies 58, the shelf assembly 14 is then pivoted (see arrow 70) so that the back plate 28 is generally aligned with the chute 26, causing the section of blocks 64 to gently slide in the tumbler's block inlet 13 via the chute 26 (see arrow 72) as illustrated in FIG. 8.

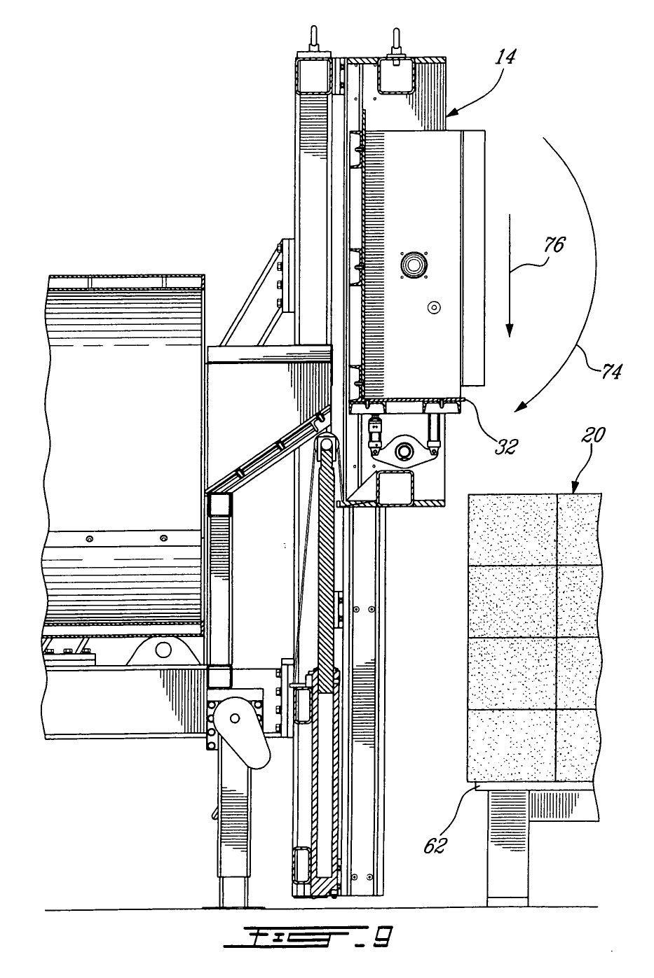

Turning now to FIG. 9, the shelf assembly is then tilted back to its initial position (see arrow 74) and lowered back to its initial non-operating position (see arrow 76).

All the sequences of operation as described hereinabove are controlled using conventional controllers (not shown).

According to a more specific embodiment of the present invention, the shelf assembly 14 is provided with a mechanism (not shown) allowing to adjust the lateral position of the back plate 28 and side walls 32. This renders the feeder 10 adaptable for different sizes of concrete blocks 18.

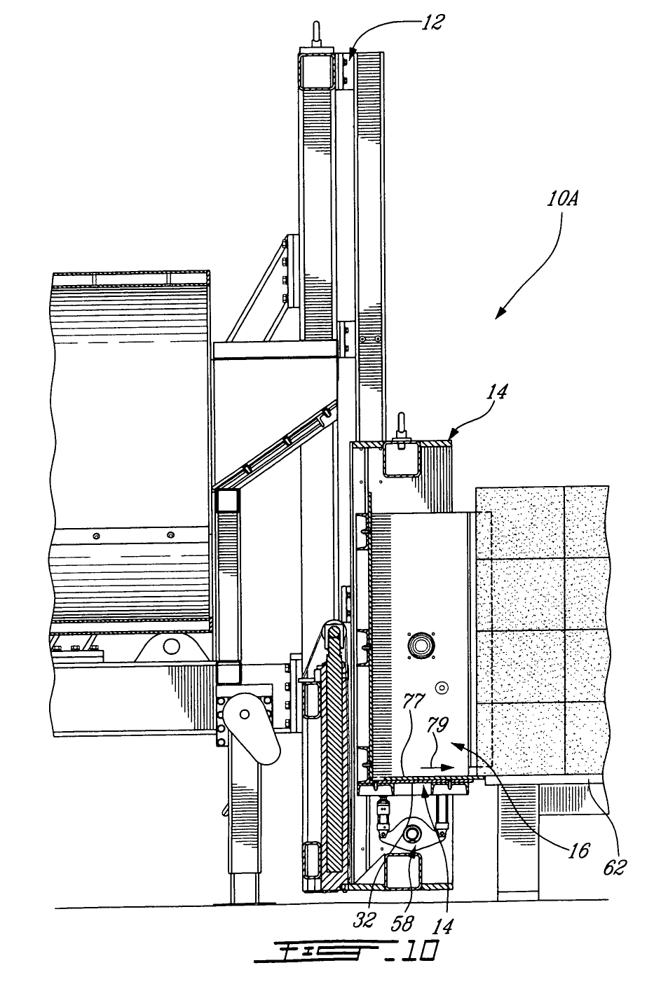

FIG. 10 illustrates a feeder 10A according to a second illustrative embodiment of the present invention. Since the feeder 10A is very similar to the feeder 10, only the differences between these two feeders will be described herein. As will now become apparent, the feeder 10A allows for an alternate section-receiving position compare to the feeder 10. More specifically, the shelf assembly 14 further includes a shift plate 77 mounted to the shelf 32 in a parallel relationship so as to be movable between a retracted position (shown in dashed line in FIG. 10) and an extended position relatively therefrom as illustrated in FIG. 10. In operation, the shift plate is moved in the direction of arrow 79 such that the shelf 32 is aligned with and abuts the cube-receiving platform 62, facilitating the transfer of sections of blocks from the cube-receiving platform 62 to the shelf 32 without having to tilt the shelf assembly 14 as illustrated in FIG. 4. Of course, in this case, a forward movement generating mechanism (not shown) is provided to allow the reciprocal movement of the shift plate 77.

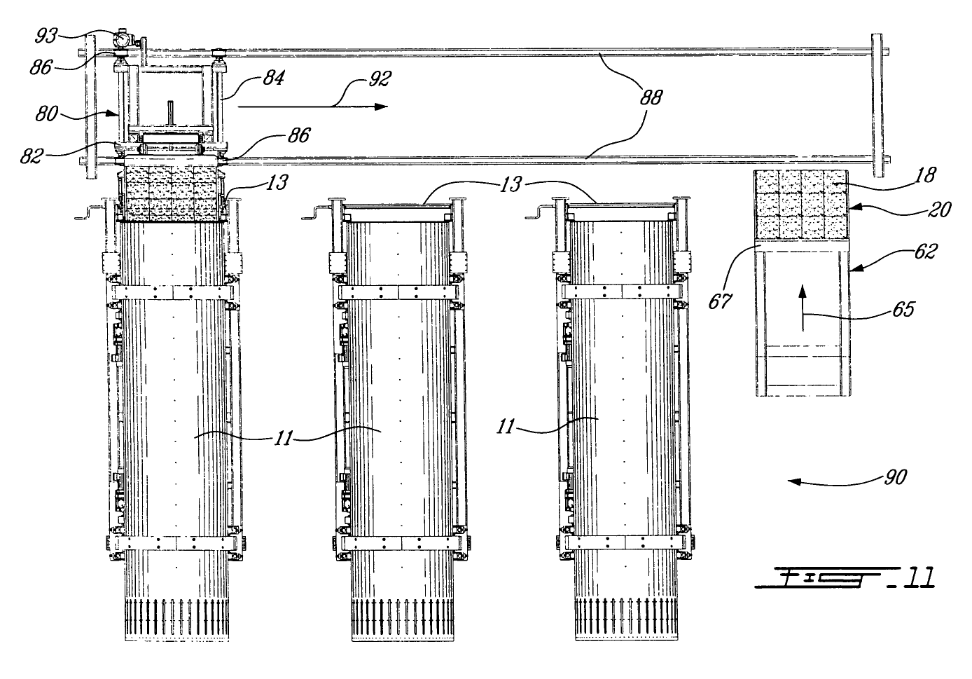

A feeder 80 for tumblers 11 according to a third illustrative embodiment of the present invention will now be described with reference to FIGS. 11-14. Since the feeder 80 is similar to the feeder 10, only the differences between the two will be described herein.

The feeder 80, and more specifically its upright frame 82 is mounted on a carriage 84 including four wheels 86 so configured as to mount the carriage 84 on parallel rail tracks 88 for movements therealong.

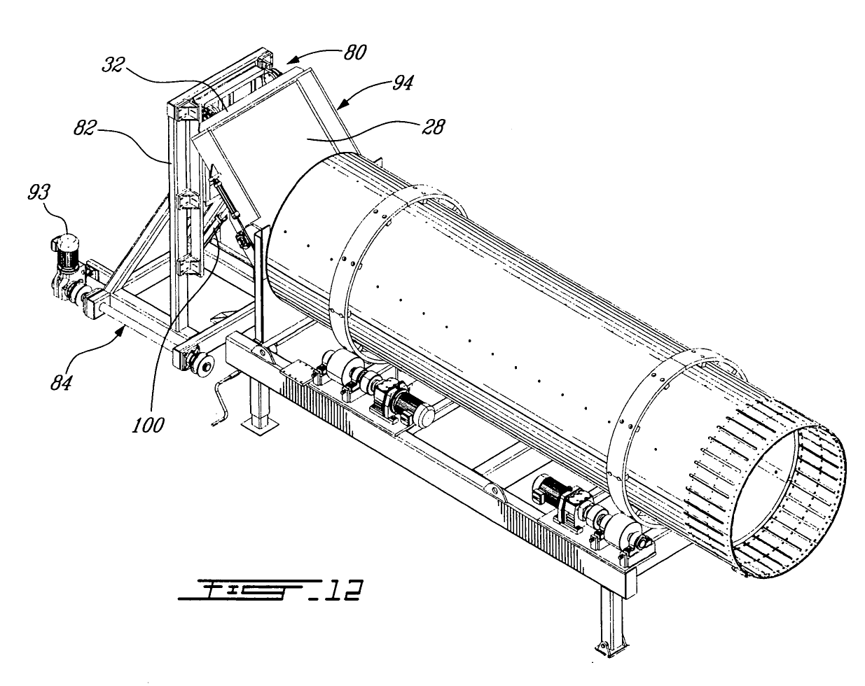

Indeed, the feeder 80 is part of a concrete pavers aging processing chain 90 further including three tumblers 11 and a cube-receiving and pushing platform 62 provided with a mechanized push-arm 67. It is to be noted that the cube-receiving and pushing platform 62 which are provided with a mechanized push-arm 67, are very schematically illustrated in FIG. 12.

The rail tracks 88 extend in front of the tumbler's inlet 13 perpendicularly from the tumblers longitudinal axes so that the feeder 80 is movable from tumbler to tumbler for sequential or selective feeding. The cube-receiving platform 62 is positioned parallel the tumblers 11 at the end of the track 88.

The general operation of the chain 90 will now be described before going into further detail with the feeder 80.

The feeder 80 is first positioned facing the platform 62. It is then put in a section receiving position similar to the one illustrated in FIG. 4 with reference to the feeder 10. After charging of a section 16 of concrete blocks 18, the feeder 80 is moved adjacent one of the tumblers 11 for feeding. The feeding sequence of the tumblers 11 may of course vary or be made adaptable or programmable without departing from the spirit and nature of the present invention. The feeder 80 dumps its section of concrete blocks in the respective tumbler 11 and then returns (see arrow 92) to the platform 62 to receive a new section and to start the above-described sequence all-over again.

The carriage is motorized for example by coupling at least one motor 93 to at least one of the wheel 86.

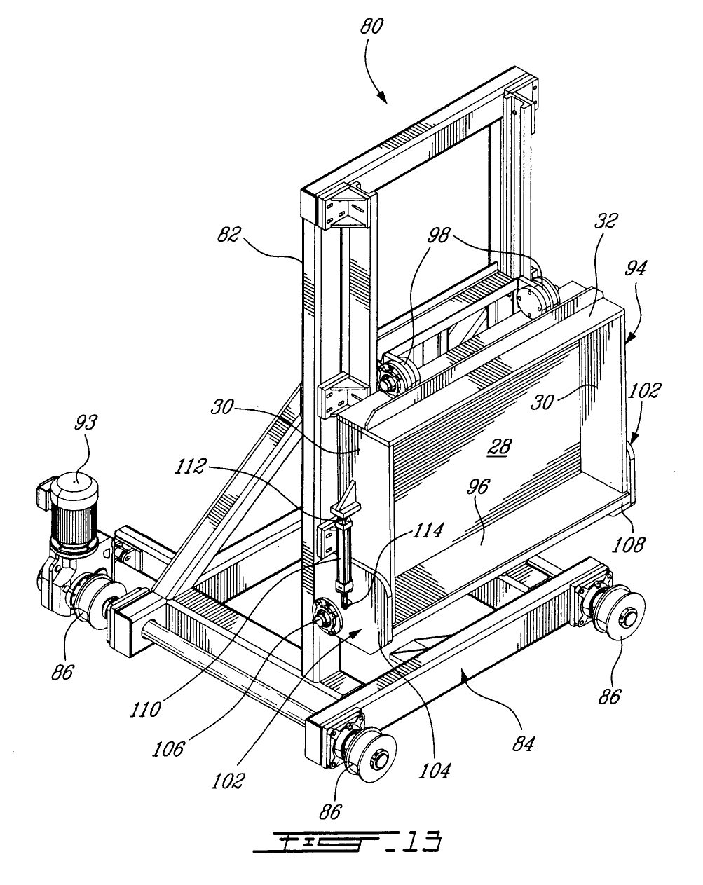

The feeder 80 will now be described in more detail with reference to FIGS. 13 to 15.

The feeder 80 is provided with a shelf assembly 94 including a back plate 28, two side walls 30, a top plate 32 and a pivotable shelf 96 opposite the top plate 32.

The shelf assembly 94 is pivotally mounted to the upright frame 82 via two top hinges 98. An actuator in the form of a piston 100 (better seen on FIG. 15), secured at an angle to both the frame 82 and the back surface of the back plate 28, allows pushing on the back plate 28, causing the shelf assembly 94 to tilt to the block dumping position illustrated inrelative to the frame 82 as illustrated in FIG. 15.

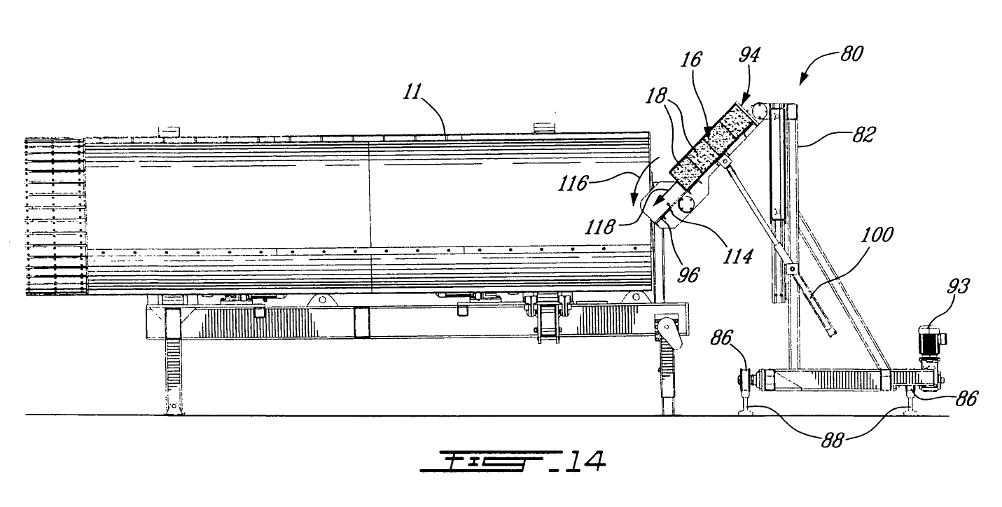

The pivotable shelf 96 is hingedly mounted via two mechanized pivot assemblies 102. Each of mechanized pivot assembly 102 includes a mounting plate 104 pivotally mounting the pivotable shelf 96 to a respective side wall 30 via a pivot pin 106, the pivotable shelf 96 being secured to both mounting plates 104 via a securing plate 108. Each pivot assembly 102 further includes a piston 110 for selectively moving the pivotable shelf 96 between its block supporting position illustrated in FIG. 14 and its chute position illustrates in FIGS. 13 and 15. The proximate end 112 of the piston 110 is secured to a respective side plate 30 and its distal extendable end 114 is secured to a respective mounting plate 104 near the center thereof so as to be biased from the pivot pin 106.

The operation of the feeder 80 will now be described with reference to FIG. 15.

The feeder 80, via its shelf assembly 94, is charged with a section 16 of concrete blocks by the cube-receiving platform 62 which is positioned at an appropriate height to transfer a section of blocks therein. The shelf assembly 94 is then aligned with a particular tumbler 11 and tilted to a predetermined angle and the pivotable shelf 96 is pivoted to its chute position (see arrow 116) causing the section 64 of blocks 18 to gently slide in the tumbler 11 (see arrow 118). It is to be noted that the pivotable shelf 96 acts as a chute when it is opened.

The pivotable shelf 96 is then closed, the shelf assembly 94 tilted back to its initial position laying flat on the frame 82 and brought back to the cube-receiving platform 62 for reloading.

Although the present invention has been described hereinabove by way of illustrated embodiments thereof, it can be modified, without departing from the spirit and nature of the subject invention as defined in the appended claims.

What is claimed is:

1. A feeder to supply blocks from a platform to a tumbler having a block inlet, the feeder comprising:
a frame to be positioned adjacent the platform and the tumbler;
a shelf assembly including a back plate, two side walls mounted to the back plate on opposite sides thereof and a shelf mounted to the back plate between the two side plates; the shelf assembly being so mounted to the frame for reciprocal movement between a block receiving position wherein the shelf is generally aligned with the platform to receive at least one block thereupon from the platform and a block dumping position wherein the back plate is generally angled with respect to the block inlet of the tumbler to cause the at least one block to slide from the shelf assembly to the inlet of the tumbler.

2. A block feeder as recited in claim 1, wherein the frame is a fixed upright generally rectangular frame.

3. A block feeder as recited in claim 2 further including a shelf mounting frame so mounted to the upright frame as to move vertically therein; the shelf mounting frame being generally rectangular and including a bottom frame member and two side frame members.

4. A block feeder as recited in claim 3 further including an actuator provided between the frame and the shelf mounting frame to selectively move the shelf mounting frame vertically.

5. A block feeder as recited in claim 4, further including two pivot pin assemblies provided between the side walls of the shelf assembly and the side frame members of the shelf mounting frame to allow the shelf assembly to pivot thereabout.

6. A block feeder as recited in claim 5 further including at least one pivot arm assembly provided between the shelf assembly and the shelf mounting frame to selectively actuate a pivotal action of the shelf assembly about the two pivot pin assemblies.

7. A block feeder as recited in claim 6, wherein the at least one pivot arm assembly includes two telescoping pivot arm assemblies.

8. A block feeder as recited in claim 6, wherein the at least one pivot arm assembly is such that the shelf assembly is generally aligned with the platform when in the bock receiving position and is slightly tilted away from the platform to facilitate the transfer of the at least one block from the platform to the shelf assembly.

9. A block feeder as recited in claim 1, wherein the frame includes an angled chute so mounted thereto as to generally be an extension of the back plate of the shelf assembly when the shelf assembly is in the block dumping position to guide the at least one block from the shelf assembly to the inlet of the tumbler.

10. A block feeder as recited in claim 1, wherein the frame and the shelf assembly are interconnected via a top hinge pivotally mounting the shelf assembly to the frame.

11. A block feeder as recited in claim 10, further including an actuator interconnecting the frame and the shelf assembly to selectively and reciprocately move the shelf assembly between the block receiving position and the block dumping position.

12. A block feeder as recited in claim 11, wherein the shelf is pivotally mounted to the back plate via hinges and further includes an actuator to move the shelf from a block supporting position when the shelf assembly is in the block receiving position and a chute position when the shelf assembly is in a block dumping position.

13. A block feeder as recited in claim 11, wherein the frame includes wheels so configured as to mount the carriage on parallel rail tracks for movements therealong, the parallel tracks being so configured as to span a distance between the platform and the tumbler.

14. A block feeder as recited in claim 1, wherein the shelf assembly further includes a shift plate mounted to the shelf in a parallel relationship so as to be movable between a retracted position and an extended position relatively therefrom.

15. A method to transfer blocks from a platform to a tumbler provided with a block inlet; the method comprising:
providing a shelf assembly including a shelf mounted to a back plate;
positioning the shelf assembly in a block receiving position where the shelf is generally aligned with the platform to receive blocks thereupon from the platform;
transferring blocks from the platform to the shelf of the shelf assembly; and
moving the shelf assembly in a block dumping position where the back plate is generally angled with respect to the block inlet of the tumbler to cause the blocks to slide from the shelf assembly to the block inlet of the tumbler.

16. A concrete pavers aging processing chain comprising:
at least two generally longitudinal tumblers provided with respective inlets; the tumblers being positioned generally parallel;
a cube-receiving platform provided with a push-arm;
tracks running laterally between the at least two tumblers and the cube receiving platform;
a block feeder to supply blocks to the at least two tumbler from the platform, the block feeder including a frame so configured as to be movable along the tracks for moving the block feeder from the platform to a selected one of the at least two tumblers; the block feeder also including a shelf assembly including a back plate, two side walls mounted to the back plate on opposite sides thereof and a shelf mounted to the back plate between the two side plates; the shelf assembly being so mounted to the frame for reciprocal movement between a block receiving position wherein the shelf is generally aligned with the cube-receiving platform to receive at least one block thereupon from the platform and a block dumping position wherein the back plate is generally angled with respect to the block inlet of the selected one of the at least two tumblers to cause the at least one block to slide from the shelf assembly to the inlet of the selected one of the at least two tumblers.

17. A processing chain as recited in claim 16, wherein the frame is provided with wheels allowing the block feeder to roll onto the tracks.
